(19) United States
(12) Patent Application Publication
(10) Pub. No.: US 2003/0135500 A1
(43) Pub. Date: Jul. 17, 2003

(54) Integrated gas supply system and computer network for enhanced user service

(76) Inventors: Henri Chevrel, Dallas, TX (US); Vinod Raghavan, Dallas, TX (US); Kevin P. McKean, Houston, TX (US); Anthony Hudson, Murphy, TX (US)

Correspondence Address: THE MATTHEWS FIRM, 1900 WEST LOOP SOUTH, SUITE 1800, HOUSTON, TX, 77027-3224, US

(21) Appl. No.: 10/303,630

(22) Filed: Nov. 25, 2002

Related U.S. Application Data
(60) Provisional application No. 60/346,356, filed on Jan. 7, 2002.

(51) Int. Cl. G06F 7/00

(52) U.S. Cl. 707/9

(57) ABSTRACT

The present invention generally describes a system and method for the integration of a gas supply system and a computer network which comprises a plurality of disparate computer systems and databases to provide an integrated system that may be searched via a web browser. An interaction manager is provided that is capable of communicating with the web browsers through a web server. The interaction manager comprises a library of compiled system component interface files which permits communication through the underlying computer architecture of each individual computer system and database. The interaction manager utilizes a JavaScript processor to generate JavaScript related to the library of compiled component interface files. Client side JavaScript generates a dynamic screen for the web browser users that may be utilized for interacting server side JavaScript to thereby communicate with the computer systems and databases.

This application claims benefit of U.S. Provisional Application No. 60/346,356 filed Jan. 7, 2002.

### BACKGROUND OF THE INVENTION

1. Field of the Invention

The present invention relates generally to methods and systems for the integration of a gas supply system and a computer network.

2. Description of the Background

As used herein, the term “HTML” means and refers to hypertext markup language. As used herein, the term “JSP” means and refers to a Java Script Page. Many of the illustrations and embodiments hereinafter described will be examples of JSP pages prompting a user for data or supplying information.

The Internet has revolutionized the modem world, connecting millions of minds over a largely unrestricted border. In general, the Internet allows communication between people from one computer to another. These connected computers have allowed almost immediate access to information and communications around the world through an assemblage of networks, nodes, portals, and/or the like. The Internet is most commonly accessed through an Internet Service Provider (ISP). ISP's provide varying levels of service and/or connection, including ISDN, DSL, T1, dial-up, and the like.

Many companies, government bodies, and/or organizations have made use of the Internet to enhance accessibility-of information. Many of these entities have found that the increased levels of accessibility have increased customer satisfaction, efficiency of operations, and the like.

### SUMMARY OF THE INVENTION

The present invention provides for an integration of systems to facilitate access and update for both internal employees and external customers. The present invention was designed to provide users greater access, control, and/or adaptability over gas supplies, customer orders, safety information, and related facets. Embodiments of the present invention allow access to a variety of parameters related to gas supply source systems through one primary portal. In various embodiments, users of the present invention are allowed pre-defined access that is at least partially dependent upon a level of access granted to the user. More specifically, embodiments of the present invention allow different access and functioning for each particular user. Other embodiments of the present invention have security features to provide control over access and provide alerts for system conditions.

In use, various embodiments of the present invention are designed to accommodate a heterogeneous mix of users both internal and external through pre-existing groups and individual profiles, with supervisory control over access and features; organization and/or presentation of present marketing, best practices, quality and safety information tied through a single interface; organization and/or presentation of reports, manuals, and other documents made available without specific internal system connectivity initiated by the user; capability to view and/or update data; organization, presentation and communication of wide alerts from source systems and/or related systems as desired, including selectivity in transmission of alert to a desired user and/or a desired user profile; information sharing; an enhanced path of communication, such as through contact lists, emergency numbers, phonebooks and the like; auto-paging and messaging capabilities; access through a single logon screen; trending and graphical information on any of the system sources and the like; ability for data entered to function on at least a batch, semi-real time and real time processing; organization and presentation of information to standardize communications, both internal and external; and the like.

The present invention will provide user service enhancement for internal users as well as external users, and/or customers. A system of the present invention will enable an organization to become “e” enabled, enabled through electronic commerce and information source. In an embodiment, the system will provide an organization's internal users, customers and suppliers with tools and collaborative processes for conducting business over the Internet. Embodiments of the present invention are specifically designed to support worldwide operations with flexibility and adaptability to support new systems and processes as they are brought online.

Embodiments of the present invention are designed to allow for and provide for process enhancement. Embodiments of the present invention will provide enhancement to customer service; accommodate a heterogeneous mix of users both internal and external through pre-existing groups and individual profiles with supervisory control of access and features; provide a way to organize and present marketing, best practice, quality and safety information from across the corporation tied in through a single interface; provide sets of relevant reports, manuals, and other documents made available without specific internal system connectivity initiated by the user; allow for capability to view and/or update related data from more that one source system; provide for a simple way for alerts to be broadcast from major system sources such as organization financials, invoice and billing; establish a collaborative mechanism through information interchange via chat, e-mail connectivity, and messaging to enhance both the internal and external user's portal experience; allow a quick and efficient way to communicate through contact lists and emergency numbers with auto-paging and messaging capabilities; establish a single logon, where feasible, to the organization information which may include data from laboratory management and data, quality management, customer service management, quality management, safety management, environmental management, and the like over a series of source databases; trending and historical information taken from corporate data sources and graphically displayed; entering data into the portal that updates source systems in batch, near-real and real time, and/or the like.

A portal that can serve as a model for use throughout an organization, including internationally linking through standardized protocols to local source systems Embodiments of the present invention will provide cost reductions. Such decrease in costs may be attributable to lower information system training costs; increase operating efficiencies (internal & external customers); and/or, increase in employee productivity These and other objects, features, and advantages of the present invention will become apparent from the drawings, the descriptions given herein, and the appended claims.

### BRIEF DESCRIPTION OF THE DRAWINGS

FIG. 1 is an illustration of an embodiment of the present invention.

FIG. 2 is an illustration of a login screen for various embodiments of the present invention.

FIG. 3 is an illustration of an embodiment system of the present invention.

FIG. 4a is an illustration of an embodiment of a computer hooked to an embodiment of a system of the present invention.

FIG. 4b is an illustration of an embodiment of a terminal hooked to an embodiment of a system of the present invention.

FIG. 5 is an illustration of an embodiment of the present invention showing interconnections to a program component personalization engine.

FIG. 6 is a more detailed illustration of the program component personalization engine of FIG. 5.

FIG. 7 is a flow diagram for an embodiment of a method of operation of the system.

FIG. 8 is a business operation component that handles personalization of data for any particular user.

FIG. 9 is a query results page for searching a laboratory system search in accord with the present invention.

FIG. 10 shows an embodiment of the system with a general flow of individualized alert data to users of the system.

While the present invention will be described in connection with presently preferred embodiments, it will be understood that it is not intended to limit the invention to those embodiments. On the contrary, it is intended to cover all alternatives, modifications, and equivalents included within the spirit of the invention.

### DETAILED DESCRIPTION

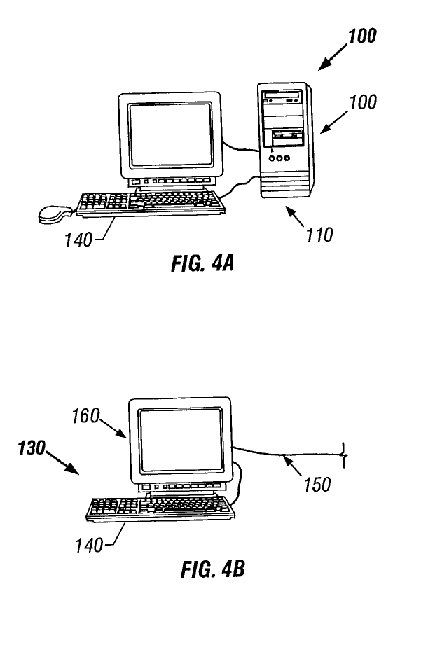

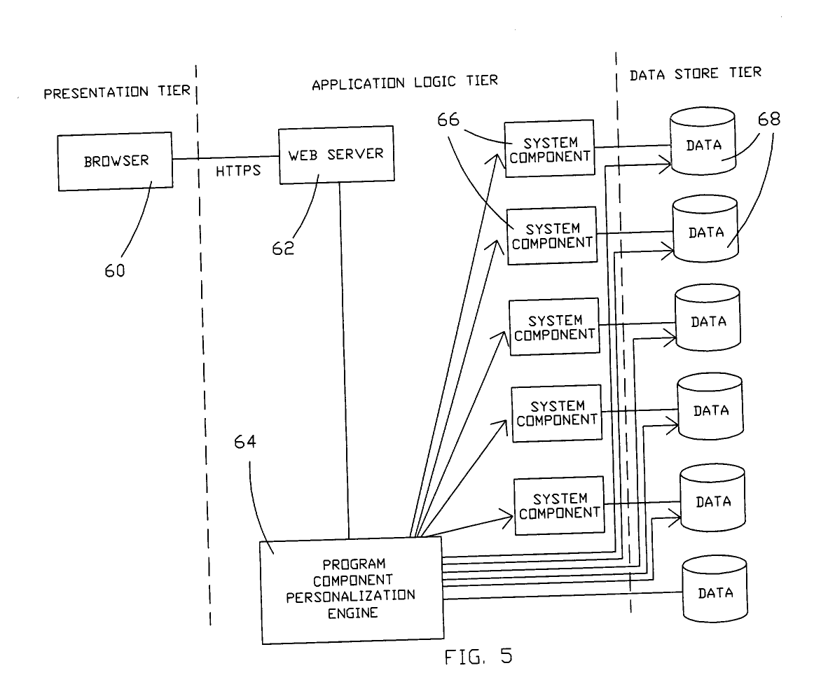

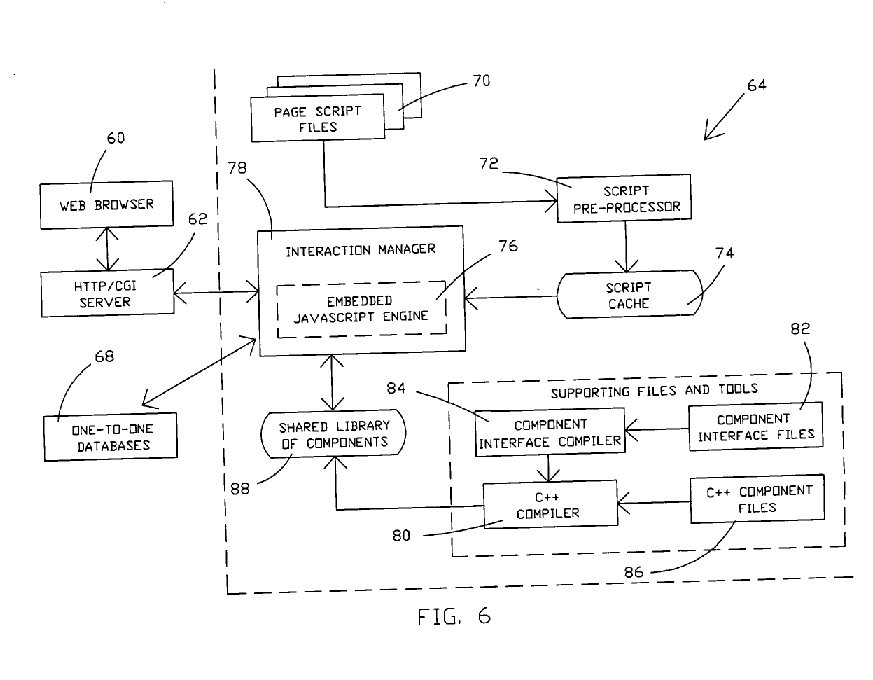

Generally, embodiments of the present invention allow access of a gas supply system to a variety of users in a variety of manners. In an embodiment, access of the gas supply system is allowed through a computer. Referring to FIG. 4a, computer 100 may be any computer capable of processing data, such as from a database 110, as well as data input for comparison, such as from a keyboard 140. However, other data storage devices and methods will be readily apparent to those of ordinary skill in the art.

As those skilled in the computer arts will recognize, computer 100 may range in size and complexity from a mainframe computer such as an INTERNATIONAL BUSINESS MACHINES 3090 series to a personal computer such as those utilizing a microprocessor such as an 80x86 or PENTIUM processor manufactured by INTEL CORP. Memory device 120 is accessible to computer 100 through any means such as those apparent to those skilled in the computer arts such as a local hard magnetic medium drive, CDROM, DVDROM, magento-optical devices, and the like. In an alternative embodiment, a memory device may be a separate data storage device operatively in communications with computer 100 such as by LAN, or a read-only electronic memory device such ROM. Other embodiments may utilize a terminal 130.

Referring to FIG. 4b, terminal 130 may be collocated with computer 100 which has database (not shown) and which does the comparison, or, as in a preferred mode, is operatively connected to computer 100 through data communications network 150. In the preferred embodiment, input keyboard 140 (or other input means) and output terminal 160 (or other output device or display) may comprise a single terminal 130 which may comprise a personal computer. Additionally, terminal 130 may be a device capable with interactive interfacing capabilities such as WEBTV marketed by SONY CORP or any other device capable of interactive interface with computer 100. Further, input keyboard 140 may be a batch input device such as, by way of example and not limitation, a card reader, a CDROM reader, an optical recognition device, a magnetic media device such as diskette or tape, or any combination thereof.

Output terminal 160 may be an interactive visual device such as a video terminal, computer terminal, or personal computer; a hard copy output device such as a printer or a facsimile; a memory device such as a CDROM or DVDROM; an electronic device such as a file resident in a memory device such as a file on magnetic or optical media; or any combination thereof.

Data communications network 150 may include terminal multiplexors, local area networks, wide area networks, dial-up bulletin boards, packet switched networks, private networks, public networks, cellular packet data networks, or any combination thereof. In the preferred embodiment, data communications network 150 is the Internet with clients and agents accessing computer 100 through any Internet accessing means, including by way of example and not limitation dial-up, DSL, ISDN, T-1, T-3, satellite, and cable.

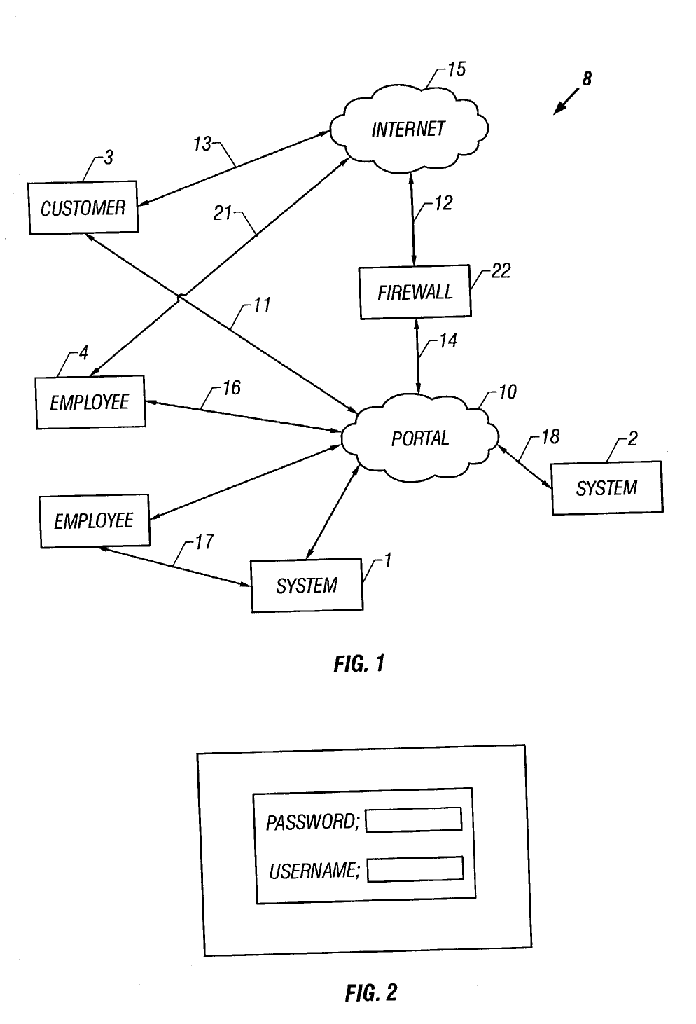

Referring now to the figures, and more particularly to FIG. 1, there is shown a system 8, an embodiment of the present invention. Embodiments of the present invention allow for the integration and/or connection of a plurality of systems, as described above in an embodiment, comprising independent and dependant systems, as will be discussed more fully below. In an embodiment, access to the plurality of systems 1,2 is provided and/or allowed across a portal 10. Portal 10 is illustrative of a centralized location and/or connection, such as a network, for a focusing of connections to both existing and later created source system(s) 1,2.

In a general embodiment, as shown in FIG. 1, access to systems 1,2 by a user(s) 3,4 is provided either across a portal 10 or directly. Users are divided into at least two groups, internal and external users. Internal user(s) may comprise employees 4, contractors, and/or the like. External user(s) may comprise supplier(s), customer(s) 3, outside sales, and/or the like. For an external user, such as customer 3, access to portal 10 is provided across Internet 15. In an embodiment, customer 3 establishes a connection/interface to the Internet 15, as is common in the art, such as through ISP 13. Customer 3 then enters a web address, such as an http address, corresponding to the address of portal 10 to navigate to the web, as is common in the art. Web addresses may be entered by any method common in the art, such as keystrokes, mouse-clicking a button, and the like.

In an embodiment, access through portal 10 is controlled by a firewall 22. Any firewall common in the art is suitable for embodiments of the present invention. Embodiments of a firewall suitable for the present invention would control access by querying a user attempting to gain access for at least one password. Other embodiments may simply require the entry of a password without specifically querying for the password, as is common in the art. Various embodiments further query for and/or require a user group name and/or group password. In an embodiment, as shown in FIG. 2, query is made for a password and a user name. However, the use of passwords and such is well known in the art and any system is sufficient for various embodiments of the present invention.

Further methods of access for external users comprise direct access and limited direct access across connection 11. Connection 11 may be any connection common in the art, such as dial up, landline, radio, and the like. In various embodiments, an external user can establish a connection directly to portal 10. In various embodiments, connection 11 is through firewall 22. In other embodiments, an external user can connect through an internal user. In other embodiments, an external user connects to an internal user.

Internal users, or users that are connected to an internal organization system and/or network, are connected across connection(s) 16 to portal 10. Other embodiments connect directly to system 1, such as through a connection 17. Access across portal 10 and/or system 1 should be controlled by a password as for external users. However, in most embodiments, an internal user will already be connected across firewall 22.

Upon entering and acceptance of a password, various embodiments display a screen that can be personalized as per the desires and/or responsibilities of the user, often referred to as a homepage. Homepages may be custom tailored for each individual user. Various embodiments allow a user to include additional information from outside an organization's source system and/or website. In various embodiments, a standardized screen is displayed with various menu choices that can be dependent upon the username/password entered by the person or upon the user's directive. It is contemplated that portal 10 allows for different screens for each user. It is further contemplated that access to source systems can be regulated such that certain users are only allowed access to certain databases and/or certain information within that database.

Source system(s) 1,2 are generally referred to as databases and hold data. In embodiments of the present invention, any of a variety of database(s)/source system(s) can be connected across portal 10, including, but not limited to, nor requiring, laboratory management system, environmental management system, communications, quality incident report(s) and corrective action(s), warehouse management, billing management, order management, maintenance management, alert systems, and/or the like.

In various embodiments, further specificity as to the level of an internal and/or external customer is necessary. In various embodiments, available profiles for internal users include, but are not limited to nor inclusive of, process operators; laboratory staff, warehouse personnel; health/safety and environment; purchasing, sales, and planning; administrative; executive management and/or the like. Profiles established for external users can include, but are not limited to or requiring, suppliers and customers.

Examples of source systems for use in varying embodiments of the present invention comprise laboratory management, safety, environmental management, communications, quality management, quality incident reports, alerts, tracking, shipping, best practices, billing, ordering, maintenance management, warehouse management, and/or the like. Further embodiments may include source systems only accessible by internal users, such as contact lists and the like.

External user, such as customer 3, will be able to perform numerous functions through a system of the present invention related to the integration of a gas supply system and a computer network.

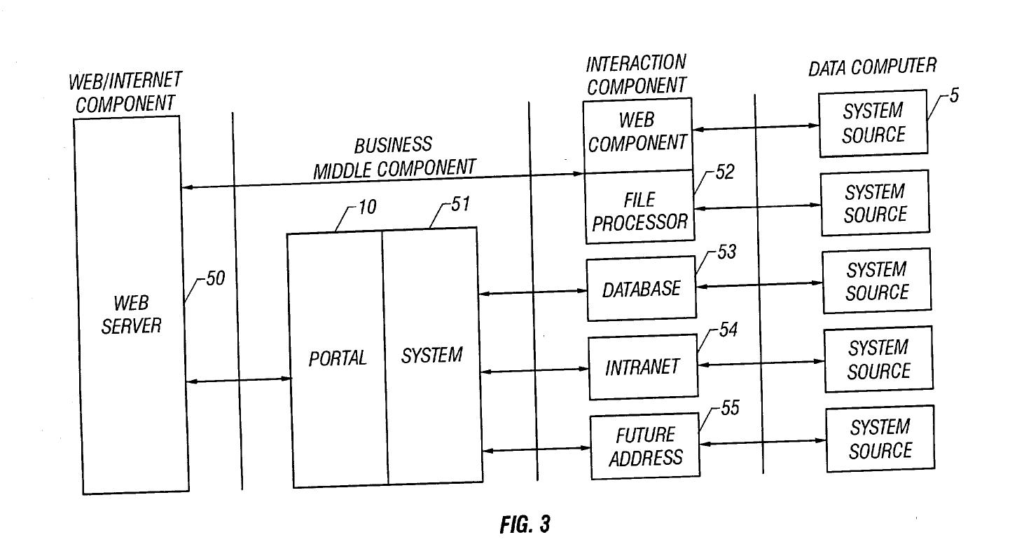

Another illustration of a system of the present invention is depicted in FIG. 3. FIG. 3 illustrates general components of an embodiment of the present invention. The embodiment of FIG. 3 is divided into four sections; web component, business component, interaction component, and source data component. Access to various embodiments of the gas supply system of the present invention is gained from the World Wide Web, such as through a web server 50. Web server 50 will have at least one individual and particular address or location. To gain access to the system of the present invention, a user or users will enter the address in a web browser, such as Netscape or Internet Explorer.

Access to the system of the present invention will begin with access to portal 10, as heretofore described. At portal 10, several access options will be available. In one embodiment, a user will enter a password, logon name, and/or the like to gain access to system 51. In another embodiment, a non-user will be able to access various parts of the system 51 that are particularly suited for safety and of benefit to the general public.

Generally, embodiments of the present invention are designed to provide access and connectivity to a plurality of systems 5. Each system 5 may be a like system or a different system. In particular, embodiments of the present invention are designed to allow access to pre-existing systems across a system of the present invention, thereby allowing a user with multiple programs of varying age to connect at least a portion of the programs and/or databases without requiring updates to every system component. It is specifically appreciated that time and money will be saved from the integration of the various systems rather than the wholesale replacement of every system. The time and money saved will cover at least the expense of replacing the system and the expense of retraining required for a new system. Embodiments of the present invention allow users to continue use of a familiar system while allowing that system to be interconnected and/or integrated with other systems.

Embodiments of the present invention utilize an interaction component to monitor, control, allow, and/or manage a users access to data in the various system sources 5. Various interaction components of the present invention include further web components and file processors 52, databases 53, intranet 54, future addresses/systems (add ons) 55, and/or the like.

Referring to FIG. 5, there is shown an embodiment of the invention wherein the system is substantially divided into a Presentation Tier seen by the Internet users. An Application Logic Tier interfaces the internet users with a plurality of different company systems, which may be located at different locations worldwide, and which typically may or may not be compatible with each other in terms of computer languages and structures. A Data Store Tier provides various databases otherwise used with the systems.

The Presentation Tier or Web tier provides interaction for system portal client browsers 60 via the chosen web server 62, such as Netscape Server or Internet Explorer Sever. The technology used to accomplish this is the JavaScript Pages inside of program component personalization engine 64, a computer program which is discussed in detail hereinafter. JavaScript provides scripting language that adds interactive functions to HTML pages, which are otherwise static, since HTML is a display language, not a programming language. JavaScript is easier to use than Java but deals mainly with the elements on the Web page. On the client, JavaScript is maintained as source code embedded into an HTML page. On the server, it is compiled into bytecode (intermediate language), similar to Java programs. A JavaScript Page is a mixture of HTML code and server-side Java Script. The server-side JavaScript is used to develop dynamic content by means of program component personalization engine 64. A Design Center inside of the program component personalization engine 64 will be used to build functional components and set up personalization through a series of wizards, setup programs. These wizards generate the JavaScript Pages. Developers, programmers of a system of the present invention, will also manually create and edit these Java Script Pages to customize them further. The JavaScript Pages utilize program component personalization engine 64 to interact with the organization's gas supply systems 66 down to the data level 68.

The Business/Middle Tier or Application Logic Tier utilizes existing program components or system component 66 functionality so that system components 66 do not have to be rewritten in order to operate as a part of the overall system provided by the present invention. All business logic of each type utilized by systems 66 is embedded in JavaScript Pages. This also allows for access to the databases 68, which may be of many various types, on the organization gas supply system, such as laboratory management, safety, environmental management, communications, quality management, quality incident reports, alerts, tracking, shipping, best practices, billing, ordering, maintenance management, warehouse management, and/or the like. Further embodiments may provide access through the application tier to other source systems, by qualified individuals, such as source systems only accessible by internal users, like contact lists and the like.

In the data storage tier, data from the organization's gas supply various systems 66, such as laboratory management, safety, environmental management, communications, quality management, quality incident reports, alerts, tracking, shipping, best practices, billing, ordering, maintenance management, warehouse management, and/or the like, will be accessed at the data level 68 to provide necessary functionality. The data store tier is particularly designed to provide functionality to stored data, including query functions and viewing functions. Thus, users may query and receive reports from databases 68 that may be organized differently in different computer systems 66 and which may not be compatible with each other in terms of structure.

A general flow of work in an embodiment is as depicted in the diagram

The browser 60 makes a request from the web server 62.

Page script files, JSP pages, request some type of transaction from a server running program component personalization engine 64. The UI layer is represented by the JSP pages. All business logic will be delegated or translated for use in the corresponding Business Objects or business programs within the layer of system component 66 which layer comprises a plurality of various computer systems 66, each of which may be quite complex in themselves.

For direct access to system components 66, such as laboratory management, safety, environmental management, communications, quality management, as well as quality incident reports, alerts, tracking, shipping, best practices, billing, ordering, maintenance management, warehouse management, and/or the like, the integrated gas supply system will establish a connection to the particular underlining system component 66 architecture. This will only be available to users within the organization's firewall.

For query functionality to system components 66, such as laboratory management, safety, environmental management, communications, quality management, quality incident reports, alerts, tracking, shipping, best practices, billing, ordering, maintenance management, warehouse management, and/or the like, the organization's system, in an embodiment, will use a JSP Component Layer, provided by program component personalization engine 64, and access those databases at the data level through dedicated server systems or portions of systems 66 corresponding to each application.

User profile information will be stored on a database

In FIG. 6, a block diagram provides the general layout of program component personalization engine 64.

The architectural blocks illustrated therein may be described as follows:

Web browser 60 is a visitor's point of contact with the site's HTTP server 62, as discussed above. In other words, the HTTP server is a web site's connection to the World Wide Web.

In various embodiments, the various methods of the present invention add a particular identifier which enables the servers to facilitate transfer of data across the overall gas supply system 8, which previously may have substantially comprised system components 66 and data 68. For this purpose, page scripts, such as page script files 70, may be utilized which are text files with a jsp extension. In various embodiments, page scripts 70 can contain server-side JavaScript, HTML tags, text, and references to Program components, such as C++ or other. The files can also contain Java object references or other text that is understood by an HTML browser. Typically, HTML tags specify that part of the information to be sent to the browser that never changes. Server-side JavaScript page script files 70 used for program component personalization 64 specify that portion of the information, which is dynamically generated. Script preprocessor 72 converts everything from page script files 70 into pure server-side JavaScript. After script pre-processor 72 converts the page, the page is held in script cache 74 and then run by the embedded JavaScript engine 76. Note that page scripts are not the same as Web pages. More than one page script can be used to build a single Web page.

Interaction manager 78 is the system's primary communication and process control for handling interactions with the HTTP server 62. Interaction manager 78 receives data from the HTTP server 62 and returns data to HTTP server 62, and controls the processing of page scripts and most interactions with the underlying servers which may be utilized in the various system components 66 and the various databases 68. For this purpose, interaction manager 78 contains an embedded JavaScript engine 76. When HTTP server 62 requests a page script, interaction manager 78 does the following:

1. Gets the appropriate path (address) to an appropriate environment which may be in system components 66 or 68

2. Validates the path (a path is the address or location for the data).

3. Checks the script cache 74 for a compiled script.

4. If there is no compiled script, it runs the script preprocessor 72 and stores the compiled script in the cache.

5. Runs the script in the embedded JavaScript engine 76.

The embedded JavaScript engine 76 runs the server-side JavaScript. Embodiments of the system may be embedded in the browsers JavaScript engine for operation directly with interaction manager 78 without any changes to the browser. Embodiments of this type may run industry standard JavaScript. This enables embodiments of the present invention to use standard JavaScript or like program on the server side of the Web connection in combination with system components to produce dynamic Web pages and Web applications. When JavaScript engine 76 encounters a reference to a particular system component, such as system components 66, then it makes calls into the appropriate compiled code, such as C++ code and the like, that constitutes the so referenced system component.

Script preprocessor 72 converts a page script into pure server-side JavaScript. The script preprocessor 72 accomplishes this by identifying all JavaScript that is to be run on the server-side. It then encapsulates all remaining text, including HTML tags, browser-side JavaScript, or plain text, within Response.write constructs.

Thus, script cache 74 is a cache of compiled page scripts. Interaction manager 78 calls for script to be produced by script preprocessor 72 on a given page script only once, no matter how many different times in the session that interaction manager 78 refers to that page script. When script cache 74 is flushed, interaction manager 78 again calls script preprocessor 72 on each page script as it is needed. Script cache 74 contains a compiled version of the script page that is utilized by the JavaScript engine 76 embedded in the interaction manager 78.

Component interface files 82 define the interface between JavaScript and design components, such as system components 66 and/or databases 68. These files specify the methods, attributes, and object creation operations that you can call in page scripts to access the functionality of the various system design components such as system components 66 and/or databases 68.

Component interface compiler 84 generates C++ source code, which provides callback functions that are registered with the embedded JavaScript engine 76. These callback functions provide the connection between JavaScript and the design objects, such as system components 66 and/or databases 68 whereby even though each system 66 may be incompatible with other systems, the present invention provides means for linking all systems without requiring reworking of each system. Thus, systems that may have existed for years may be interconnected for use as system components 66 in accord with the present invention. To accomplish this, component interface compiler 84 compiles the component interface files 82 into C++ source files, which are then compiled by the C++ compiler.

Component definitions of system components 66 are written in C++, or other like language. These JavaScript-visible components are C++ objects which contain code to do particular tasks related to providing the information sent to the visitor's browser 60 or processing the data received from the browser 60.

The C++ components are compiled into one or more shared object libraries 88, which are loaded by interaction manager 88 when it begins running. Thus, shared library of components 88 comprises a set of shared object libraries defining elements of system components 66 and/or databases 68 which, as stated above, are loaded by interaction manager 78 when it begins executing.

An example of the operation of an embodiment of the present invention is as follows:

In an embodiment, the system program components 66 of the present invention are C++ objects that are visible to JavaScript, that is, they can be called directly from server-side JavaScript scripts. These system components 66 are effectively composed of three layers as described in the following table. Each of these application components are used in the overall development of the system portal 10, in various embodiments of the preset invention:

| Layer | Purpose |
|---|---|
| JavaScript | Allows BroadVision components to be used in JavaScript |
| Interface | scripts. Specifies the methods and attributes that can |
| | be called on a component in a JavaScript script. |
| Component | Passes information between the JavaScript layer and the |
| reference | component implementation. Also provides the memory |
| | management semantics |
| Compoent | Does most of the actual work. C++ classes in this layer |
| implementation | make calls into the BroadVision C ++ client side toolkit |
| | or directly into the back-end servers via IDL interfaces. |

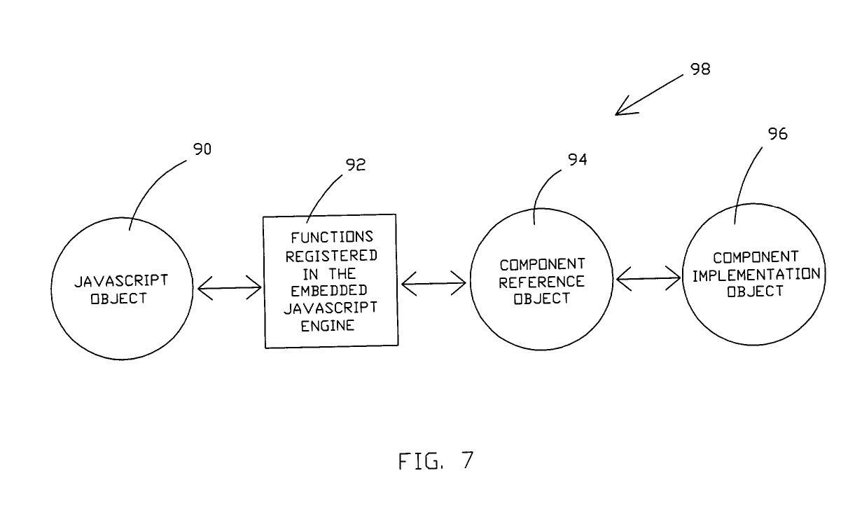

When a system component 66 is used with a script of the present invention, there is an object for each of the three layers. The JavaScript layer includes a set of functions for each system program component 66 that are registered with the Netscape JavaScript engine 76 embedded in the interaction manager 76. When the embedded JavaScript engine 76 encounters a reference to a system program component 66, then it runs these registered functions. These functions, in turn, make calls into the system component reference layer that communicates with component implementation classes. This series of calls is shown in FIG. 7. For each type of system program component 66, or component reference object 94 as per FIG. 7, there are a set of registered functions 92 that provide calls into the component implementation object 96, or the actual specific system component such as a system program that has been in operation prior to development of the present system, for each particular instance of that component type. Program components are useful within server-side JavaScript script objects 90 that can run in the embedded JavaScript engine. Various embodiments of such scripts may, if desired, have the following characteristics:

Uses syntax similar to Microsoft active server pages.

Support JavaScript-visible component objects that conform to the Program component technology.

Uses industry standard JavaScript.

JavaScript is an interpreted language that is loosely typed and has built-in automatic memory management. C++ is a compiled language that is very strongly typed and requires adherence to specific memory management semantics.

Presentation of system portal 10 of the present invention can be of any common browser, such as Netscape or Internet Explorer Browser with a script engine for processing the JavaScript. Presentation of system portal 10 will be alike for every user. However, features are built into embodiments of the invention to allow a user to personalize the system portal. The scripts, both the client side script and server side script, make the presentation layer dynamic and support the complete separation of application logic from presentation logic. The client side script, interpreted by the web browser, handles the simple, independent logic such as syntactic validation. The server side scripts, which are interpreted by script engine 76 within interaction manager 78, determine the action once a new request is received. The server side script executes the application objects (Business Objects) hosted in the processing layer.

Various embodiments of a system program and/or system portal of the present invention provide components for high speed caching, session management, and security management such as SSL. Various bit-sized encryptions may be used with embodiments of the present invention.

The operation/processing layer of the system program of the present invention consists of at least 2 components; the business operation component and the vertical functional component. Each component processes a different system function. A business operation package will handle the personalization, content management, and the matching rules. A vertical functional component will handle the interfacing with the backend interaction as well as the necessary logic processing, such as business logic and interfacing the existing organization systems.

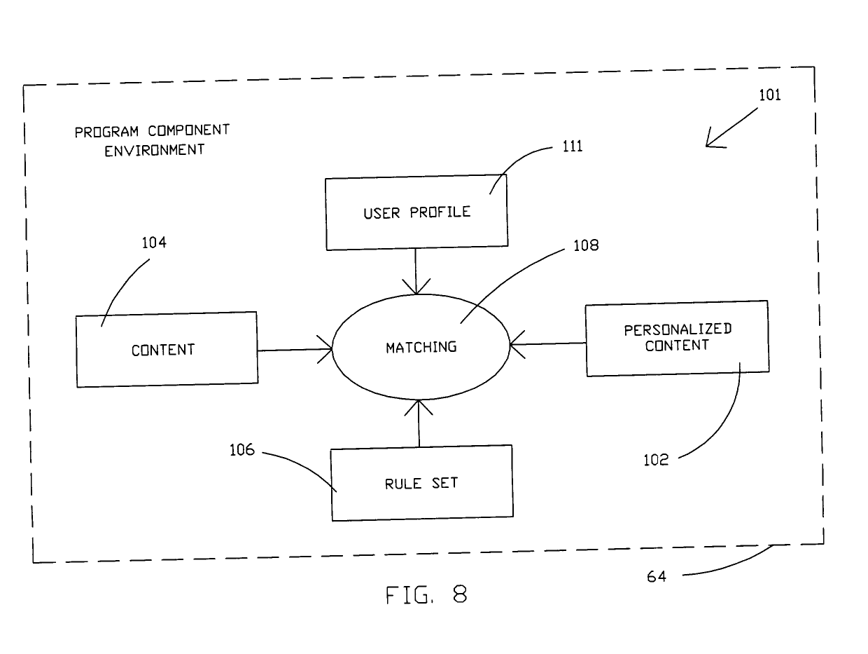

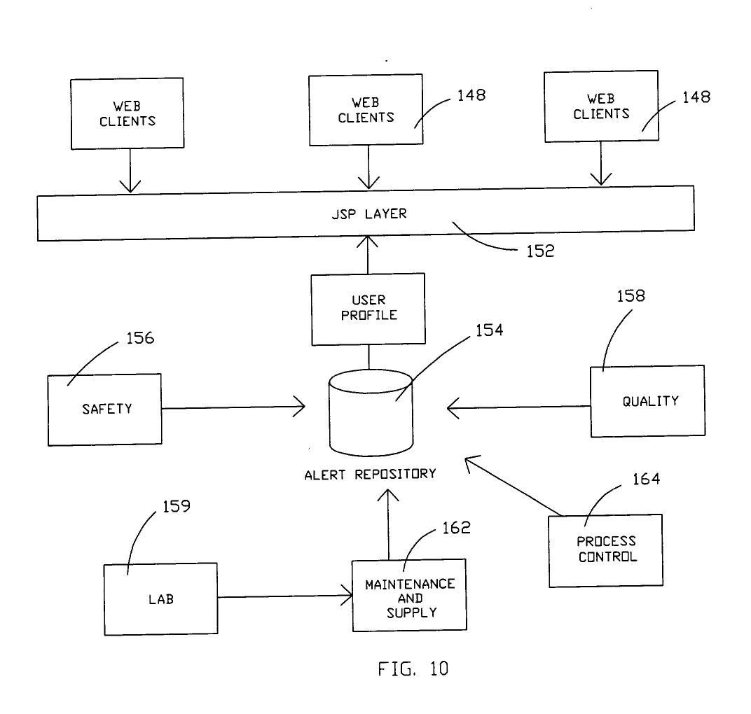

FIG. 8 provides a basic overview which discloses generally how program component personalization engine 64 may be utilized to operate for personalization of content with respect to each user whereby each user has a particular user profile 111. User profile 111 is utilized within business operation component 101 to provide personalized web content, an example of which is also shown in FIG. 10 wherein an alert system is provided. One embodiment may include the content management module 104 which is capable of providing, for instance, the requested content. Matching control 108, is used with rule set 106 to filter content 104 based upon the level of access permitted and thereby provide personalized content 102 which a user can obtain through web browser 60. The system program of the present invention is preferably based upon client-server existing architecture. This feature allows full control of the business behavior in each existing system in real time to perform tasks like adding new rules for incentives, advertisements, observation, defining alerts on certain conditions, and generating targeted email to reach a targeted audience.

The Visitor Interaction component is particularly designed to enhance user interactivity with systems of the system program of the present invention. The visitor interaction component is designed to allow limited access to users without requiring formal logging on or entry into the system. Such functionality allowed without logging on includes navigation through the pages, utilization of certain tools, access to safety pages, quality pages, organization information, help pages, articles, information about products, and/or the like.

Embodiments of the present invention utilize output content that is selectively personalized. In general, an output screen of the present invention will contain at least one menu item with at least one icon or selectable zone for entry into at least one of a variety of systems within the system portal. Preferred embodiments have a plurality of menu items. The output is the personalized content. Each user will be granted access to menu items that are within the users granted level of security access.

Various embodiments of the present system will present screens to the user with standard menus, a personalized menu, standard static displays, and dynamically generated text such as that based on user input, e.g., queries, searches, etc. as discussed hereinafter.

Access to and operation of embodiments of the gas supply system of the present invention is achieved when the user, whether external or internal, clicks a link or button (on the menu or on at least one of the menus) on the system portal, a generated page is sent back to the browser. In an embodiment, the following steps are performed: 1) User enters their username and password and clicks Login and/or Logon; 2) The click action sends the control back to the same page; 3) Create a username method; 4) Validation of the user's password; If the username and/or password is not valid, the login page is redisplayed with an error message. Otherwise proceed; 5) Check to see if the user is logging in for the first time. If the user is logging on for the first time then they are directed to the change password JSP page, otherwise the user is directed to the home page.

For establishing a new account, in various embodiments of the present invention, the system queries the new user for information to establish a new account. In one embodiment, 1) User clicks on “New Account Request” from the menu; 2) User fills out the required fields and clicks “submit;” 3) The information is collected and formatted; 4) An email is generated and sent to the administrator; and, 5) The Administrator is responsible for approving and adding the user.

In an embodiment, account information collected may be stored in a data matrix or database, such as name, email, phone, organization, password, department, customer number, and the like. It will be appreciated that there are many possible data entry/user account screens that may be utilized. In this embodiment, three data groups are collected. One, personal information on the user, such as name and the like. Two, account access information, such as password and username. Three, account access allowed, such as which customer's information can be accessed by the user and/or what information can be accessed.

This information can provide basic information for embodiments of the invention as needed. In an embodiment, this information is maintained within the organization's internal directory and may only be modified from a user within the firewall of the system, to protect system integrity. In other embodiments, access and modification is allowed to select users.

Other embodiments incorporate like procedures for a variety of functionality, including, but not limited to, security updates, password changes (manual or automatic), new user forms, and the like.

In an embodiment, a gas supply system of the present invention is preferably provided with a feedback section. The feedback section allows internal users, external customers and the like to make comments about the system to a system manager or the like. In an embodiment, comments are classified in different categories, thereby allowing a manager of the particular category to respond to and/or accept the comment. Further embodiments may incorporate response groups or problem solving groups to address each comment and/or a comment that is determined credible. In an embodiment, the feedback function enables an internal user or customer to view, complete, and email a system feedback form to a system manager. The feedback form is used to gather comments, suggestions, evaluations, and other concerns that users may have pertaining to the system portal. In an embodiment, the feedback form consists of a single, online request form residing on the system Portal. The form is accessible by selecting the “Feedback” link located under the “Support” menu on an embodiment of the system navigation bar. Various embodiments further incorporate the use of verification pages and/or replies that are automatically sent to the user making the comment when the manager views the comment.

In an embodiment, the Feedback Form simply consists of HTML and JavaScript, both of which are encapsulated into a single JavaScript Page (JSP). The HTML contains a form that collects the information fields entered by the user. The JavaScript ensures that all the fields are filled out and formatted correctly when the user presses the “Submit” button. Once the information fields are verified, they are passed to the Feedback Result JSP. The Feedback Result JSP also contains a combination of HTML and JavaScript. First, the information fields are formatted into a single text message, which is later inserted into the body of an email message.

Other embodiments further incorporate functions to allow a user, both internal and external, to order and/or view a Service Request form, complete it, and email it to the appropriate organization representative and/or print it. The Service Request consists of a single, online request form residing on the system portal. In an embodiment, access to this form is controlled by the system, such that only certain users can gain access. Access, in an embodiment, may be gained through a link located under a menu bar. Links, as used herein, refer to information locations within a system of the present invention and can provide automatic connection.

In an embodiment for requesting service from a department, such as from a laboratory, quality assurance center, environmental protection center, production facility, and/or the like, a user would follow a procedure as such: 1) User selects the “Labpack Service” link from the menu; 2) User fills out the required fields and clicks “submit;” 3) The information is collected and formatted; 4) An email is generated to the department manager; 5) The email is sent to the manager requesting service; and, 6) the system displays a confirmation page to the user to verify that the Service request was made.

As with all of the functions of the system, much of the required information will automatically be loaded from the users personal information into fields of the function.

The service request form simply consists of HTML and JavaScript, both of which are encapsulated into a single JavaScript Page (JSP). The HTML contains a form that collects the information fields entered by the user. The JavaScript ensures that all the fields are filled out and formatted correctly prior to allowing the form to be submitted for further processing. The form may automatically be submitted for processing or to submit the form may require action by the user, such as the user pressing a submit button and/or the user controlling a pointing device such as a mouse to select the submit button on a visual display of the system.

Another function provided in embodiments of the present invention is query functionality. Query functionality is a process that enables a user to search requests, orders, and the like. Requests may include the requests mentioned in reference to the service requests above or any comparable request functionality. Orders include, but are not limited to, product orders, supply orders, and the like. Query functionality of the present invention is particularly adapted to accept a wide variety of data for searches, such as 1) Criteria can be partially entered; 2) If date is entered, query function will query data from that date forward; 3) visual and/or audio indicators when no record matches; 4) Query returns a list of identifiers or results based upon the entered data; 5) Data queried may be stored in specific identified sectors to speed computer processing of request, such sectors would allow for updates as necessary to change or modify the data in the sector; 6) results from query can be sent to a printer, screen, electronic mail, another user, 7) and/or the like.

In various embodiments, access time and run time is increased by much of the processing in query functionality occurring on or within the queried function, such that the data processing occurs within components or separate programs that are accessed by a gas supply system of the present invention. In fact, in a preferred embodiment, a gas supply system of the present invention is a manager of a plurality of independent systems, such that the gas supply system only requests data from applications that are run on separate and independent systems. The data queried by the gas supply system can then be loaded through a spreadsheet function and displayed to a user.

In an embodiment, query functionality may be accessed through a web page, such as a search criteria page. The search criteria web page requests information necessary for a query of the proper database. For instance, when querying a customer database, such fields as purchase order number, order date, customer name and/or number may be requested.

Typically, not every field must be filled in prior to submission. In an embodiment, the search criteria page requires one of at least the order number, customer number or name, purchase order number, and order date. Systems of the present invention are particularly configured to accept submitted information, query a database and return further information. For example, if only a purchase order number is submitted on the search criteria web page and then the form is submitted, a search results page would be displayed listing that purchase order from the database queried. Likewise, if only a customer name was submitted, a search results page would be displayed listing all the orders from that customer in the database queried. Other query options may be made to return various search results pages as is known in the art. However, if no data is found, a return page will be displayed stating that no data was found. An example of a search order may include items such as order number, customer number, PO number, week beginning, and other identifiers as well as search control buttons to start the search, clear, change the search data, and so forth.

In embodiments with a search results page, the search results page can be configured to provide any information concerning a purchase order, other order, and/or request. In an embodiment, the search results page provides all information about an order, including, but not limited to location where order is being filed, date of order, date order was filled or is expected to be filled, reason for delay (if any), location codes and the like. In various embodiments, a more detailed result page may be requested. A more detailed results page may provide additional information, such as originator of order, more thorough breakdown of order, parts of order filled, and the like.

In various embodiments of the present invention, a query function or query type function is provided for forecasts. Included in this forecast query functionality are product demand forecasts, customer specific forecasts, product use forecasts, organization growth forecasts, supply forecasts, facility expansion forecasts, and the like. Other embodiments of the present invention may have a plurality of forecast types, such as product trends, division trends, organization profit trends, raw material trends, price trends, competitor trends, technology trends, electricity usage trends, cost trends, and the like. Forecast querying is accomplished in the same general manner as querying in other areas and may be limited to internal users or users with certain clearance if desired. An embodiment of a process of the present invention for querying uses a process as is generally described following: 1) A User selects the Forecast option; 2) The user fills out the required fields and submits the search, such as by selecting a field with a pointer device and/or manual input of data; 3) The result page is displayed from a query of the database; 4) the user selects a forecast type; and (5) The forecast type is displayed. The forecast may be displayed in the form of a graph, data, and/or the like.

Embodiments of the present invention further have an MSDS query functionality. This function allows users, both internal and external, to search and view MSDS datasheets. MSDS datasheets are Material Safety datasheets. Chemicals and/or compounds handled at an organization are required to have a current MSDS. These MSDS's provide safety and related information about the chemicals The MSDS query functionality is accessible through inside the firewall and outside the firewall. Various embodiments allow access of the MSDS's to non-users, for example through the logon page of the system. In this manner, the information contained in an MSDS is available to any person, whether a user or not. In an embodiment, an MSDS query functionality of the present invention is as follows: 1) a user selects MSDS query function, such as through a link on a menu and/or manual entry; 2) the user fills out the required fields and submits the search, such as by selecting and/or clicking a requested field; 3) The Result Set page is displayed; 4) the user selects an MSDS; and, 5) The selected MSDS is displayed. Further embodiments of the query function of the present invention may further incorporate an ability to access multiple MSDS's at one time, search MSDS's by partial entry of chemical or compound, search MSDS's by organization facility (what chemicals are at a specific facility), search MSDS's by safety precautions, and/or the like.

Various embodiments of the system of the present invention that incorporate a MSDS query function make the MSDS query available from every JSP. Other embodiments constantly compare data from the different MSDS sheets and compare data from selected MSDS sheets to other data, such as data from another portion of an order; data from other chemicals kept on a facility, such as a customer facility, to check for any reactions that may occur or toxins that may result from contact of the chemicals or substances. Outside users, such as customers, in some embodiments, will have the ability to load information about their sites and/or complexes, such as potential and/or actual chemicals on site. In this manner, embodiments of the system of the present invention will be able to display warnings and/or JSP pages detailing potential hazards of moving and/or using chemicals on the user's site and/or complex.

Further embodiments of the present invention have lab search query. Lab search results query can be set up to an internal user to search and view lab reports (reports including, but not limited to sample summary reports and certificates of analysis). The search form is accessible through the system to an internal user. The function can be accessible through any number of JSP's. In an embodiment, the lab search query is available from a menu bar on the main page a user encounters after logging on to the system. In other embodiments, external users, such as customers, can gain access to certain features of the lab report ranging from full access to access that is limited to determining whether or not the sample as been run in the laboratory.

To facilitate the entry of lab reports on the system, in various embodiments, members of the lab have access to an internal database that contains the lab reports. In an embodiment, laboratory personnel are granted access to the database only to enter data into the system. In another embodiment, at least one member of the laboratory personnel is granted access sufficient to make changes to entered data. Granting various levels of access to different personnel allows management control over the adjustment of recorded data, thereby enhancing the integrity of the data and providing for quality standards.

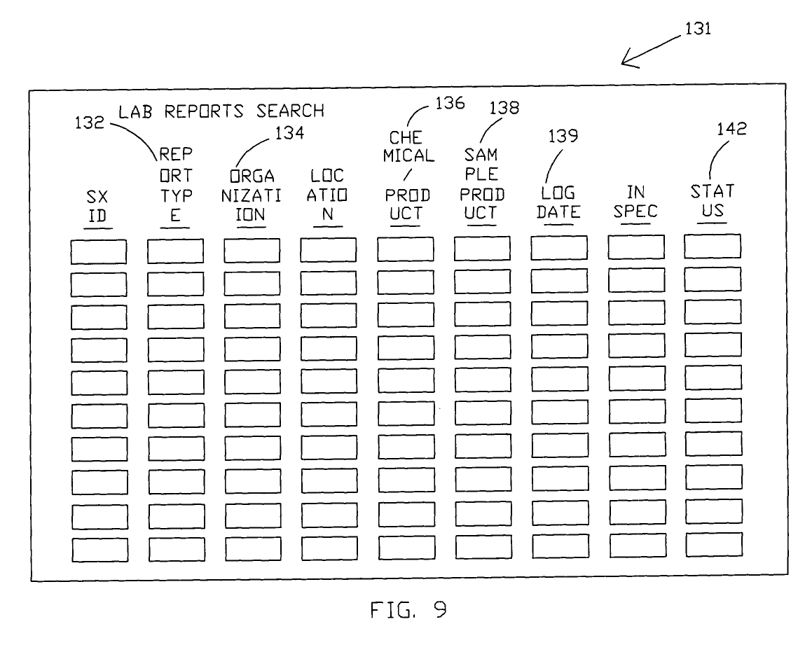

As with other query functions of the present invention, a submitted query will return a results page or a page indicating that no results could be found. An embodiment of a JSP returned is as shown in FIG. 9 as lab reports search results page 131. Thus, the present invention provides access through the browser 60 to a system component 66 which may be utilized for lab reports. A query by a user may utilize interaction manager 78 to search databases such as data bases 68 to obtain results page 131 which may contain information such as report type 132, organization 134, chemical or product 136, sample product 138, log date 139, status 142, and the like.

An embodiment of the present invention converts lab results into certificates of analysis which may comprise a lab report listing elements such as chemicals. product, sample type, vessel, vessel serial number, lot number text ID, status, login date, completed date, description, and so forth.

Certificates of analysis (COA) are often created when product is made, usually a batch or certain volume of product. COA's are often required to be created with organization batches or samples of the batches to identify the properties of the product. For example, a tube trailer filled with a nitrogen rich gas would be required to carry a COA stating the purity of the product, other contaminants, and related safety data. Embodiments of the present invention allow for the creation of a COA from any computer with access to the system portal of the present invention. In this manner, rather than requiring an individual from a lab to send a COA from a product, a user can retrieve a COA by running a particular query from the menu item of the gas supply system of the present invention.

Other embodiments can utilize a COA for other accepted purposes. An added benefit of the present invention is the security provided the COA's integrity. Even though multiple users may have access to create a COA, only limited numbers would have access to change a COA. In the event a COA was changed, in certain embodiments, a warning would be issued requiring the destruction of all previous COA's issued on the product. To facilitate such a warning, the production of COA's of the present invention can be coded and controlled, such that the system of the present invention tracks which users requests COA's, keeps copies of the COA's requested, sends notices to other people that a COA has been requested, and/or the like.

Other benefits of embodiments of the present invention include functionality that allows an outside user, a person or entity not related to the system, such as emergency personnel, to be able to quickly access the relevant information about a product. In certain situations, such as a spill or leak, this functionality will greatly enhance safety.

A general procedure a user can utilize in querying the lab search report is as follows: 1) User selects a lab search report link from a menu or other location; 2) the user inputs the required information and submits the query; 3) a result page is displayed with the queried data; 4) the user selects a format for the requested data; and, 5) a report (Sample Summary/Certificate of Analysis) is displayed. However, various other embodiments may utilize different procedures in requesting the appropriate data.

Other query functions available on embodiments of the present invention include safety, environmental management, communications, quality management, quality incident reports, alerts, tracking, shipping, best practices, billing, ordering, maintenance management, warehouse management, and/or the like. Such further and other queries are accessed in the same manner as heretofore described.

Further functionality included in system portals of the present invention includes ability to View Certificates of Analysis, View Sample Summary Reports, View History of Sample Summary Reports & Certificates of Analysis, Pass/Fail Sample Alerts, Sample Status Alerts, Quality Alerts, SOP Alerts, Statistical Process Control Graphical Trending (gas and chemical), Queries for old data, and/or the like.

Embodiments of the present invention provide access to shipping data concerning products, gas, pipelines, cylinders, samples, and/or the like. Query functionality includes queries By Barcode/RF tag, By Item, By Container, By Lot Number, By Part Number (Internal), By Part Number (External), By Location, By Status, By Expiration Date, By Pending Orders, By Gas Cabinet or CDU, and/or the like. Data such as Inventory Reports, Cabinet and Usage History, Alerts, and/or the like may be queried from the source data systems. Alerts for the present invention may include alerts Expiration Date (Various time length i.e. 1 month, 3 months, 6 months . . . ), minimum Inventory, Back Orders, and/or Procedure Violation.

Embodiments of the present invention further contain system control and data acquisition databases. These databases can control the frequency of alerts for sampling, alerts for system portal operation, can identify system problems, system non-functionality, system slowdowns, and/or the like. Typically, a system of an embodiment of this type would be a software based control program, such as produced by Microsoft and/or the like. Various functions controlled by embodiments of a control system can include network mapping information, such as Configuration of major components, Manufacturer, Model, Serial Number, Size, Capacity, System Tools Connected, Piping Layouts, Valve Locations, System Tool Locations, History of Event analysis, and/or the like. Various alerts created by a control system of the present invention can be system related or process control related, such as Excess Flow Rates, Low Flow Rates, Excess Total Usage, Continuous flow from a system which normally flows has an intermittent usage, Temperature, Pressure, Flow Throughput, Purity, Consumption, Cylinder Switching for process controls and system overload and/or system malfunction for system monitoring.

Embodiments with an environmental management or information database provide functionality such as View/Search Bills of Lading, Access MSDS, View Regulatory Data-Link to Industry Web sites, Edit/Create Service Request Forms, Summary Reports of Service Requests, View Pickup Schedules, View Audit Surveys, Lab Pack, Sampling, Analysis, and Waste Handling Procedure, Required PPE data, Accident Reporting Procedure, Forms and Contacts, Training schedule, Interface with the new container tracking system, and/or the like. Various alerts may include Change in MSDS or new MSDS issued per site and/or Government Permit Expirations and Reporting Quantities.

Various embodiments of a quality reporting system or quality control system of the present invention provide functionality including, in some embodiments, View Reports (Trend Reports, Quality Team Progress Reports, etc.), View Workflows, View/participate Discussion Area on Quality Incident Report (QIR) and Best Practices, View Customer Complaints, Alerts (including, but not limited to nor requiring, Accident Reports, QIR Updated, Safety), Processing of the data by: Date, Gas, Location, Country, Seriousness (impact), customer, View metrics on Quality incidents statistics based on Key words input during edition of QIR cards), Input QIR following a key word architecture, Extend the QIR to minor incidents and improvement suggestions, (see TGCM FAQ forms), and/or the like.

Further functions of the present invention can allow access to organization directories, contact lists, work orders, maintenance, best practices and/or the like. Inside users and, in some embodiments, outside users will be able to access organization wide directories to better facilitate communication within an organization.

Various embodiments of the present invention provide multiple levels of security for components of the system. In various embodiments, security will be maintained in the system portal in multiple layers. Various levels of security include physical level security; firewall, program component; application level security, data level security, and application level security.

Firewall security is common in the art and can include opening and closing specific ports and the like upon entry if a password, recognition of a marker, such as a carrot, and/or the like.

Other functionality of embodiments of the present invention includes alert functionality. FIG. 10 provides one possible embodiment of the present system with alert functionality allow users to view alerts across a plurality of source systems and/or system components from the system portal of the present invention. In various embodiments, individualized alerts may be broadcast upon a user logging in for each of web clients 148. Each users homepage can be configured to provide alert information for matters of responsibility and/or concern to that user. The alerts are provided through JSP layer 152 which includes both browser JavaScript and server JavaScript. Alert repository 154 may be utilized to receive alerts from many different system components 66 such as safety 156, quality control 158, one or more labs 159, maintenance and supply 162, process control 164 and the like. User profile 166 is utilized to filter the alerts for the particular user among web clients 148 to provide the type of alert for each user on a personalized basis. In operation, the user logs in to the server, the system checks the database for proper authentication, alert tables are queried and the user may receive an alert or be directed to an alert page.

Other embodiments with alert functionality notify users via e-mail when an alert within the user's responsibility is signaled. Alerts can be activated for all user groups and for all functionality.

Program content security can include security that is based on the user profiles that reside in the system program component database. The system portal users will login to the portal with a username and password. The system program component verifies the username and password and retrieves the user profile from the program component database. The user profile will contain a user group or role. The server-side JavaScript that Program component uses can retrieve the user role from the Program component session information. Using the role, the JavaScript can be written to control the content that the user will see and can be used to control access to other applications that will be used via Program component.

Program component application security is maintained by defining database user accounts. The accounts will be set up to enforce general data level access rules (i.e., read only). Application logic written in system program component will make use of these connections retrieve data from the system program databases.

Application level security is the security provided to the individual databases, the read/write function of the databases. This level of security is typically configured to only allow internal users to gain access. However, in various other embodiments, users outside of the firewall will have access to the databases. Security controls placed on access to the databases are usually in place to protect system integrity and prevent unauthorized tampering with the various source systems except for those allowed access.

Other embodiments of a system of the present invention associate web servers that provide the capability to run server-side JavaScript inside the web server. This blurs the distinction between Web serving and application serving. However, as an application becomes larger or more complex, application serving provides greater speed of processing. Other embodiments of a system of the present invention are one entire web side server application with little to no processing on the application side.

In summary, the present invention effectively provides an integrating system or means for integrating a plurality of typically disparate computer programs and/or databases into a single integrated system accessible by one or more web browsers wherein the web browsers being operable for utilizing a scripting language, such as JavaScript, to produce a dynamic screen. A web server operable for communicating the scripting language to the web browsers and receiving a response from the web browsers. The web server and the plurality of system programs are separated with respect to each other such that there is no direct communication between the web server and the plurality of computer programs. The web server and the plurality of databases of information are also separated with respect to each other such that there is no direct communication between the web server and the plurality of databases of information. A program component engine is operable for accessing the plurality of databases of information and for communicating with the web server. The program component engine is also operable for communicating to the plurality of databases of information in accord with said response from said web browser. A scripting language generator is utilized by the program component engine for generating scripting language based on the information in the plurality of databases and communicating the scripting language to the web server. The one or more browsers are thereby able to connect to web server with the dynamic screen for querying the plurality of databases for information and/or or computer programs and can interact therewith, depending on the level of communication allowed based on a user profile.

In another embodiment, the present invention provides a system for integrating a plurality of computer programs and a plurality of corresponding databases of information into an integrated system accessible by one or more web browsers. The browsers are operable for utilizing a scripting language to produce a dynamic screen. The system comprises elements such as, for instance, a program component engine operable for accessing the plurality of computer programs and the plurality of databases of information, the program component engine may be operable for generating scripting language, and a web server operable for communicating with the one or more web browsers. The web server and the plurality of system programs are separated with respect to each other such that there is no direct communication between the web server and the plurality of computer programs. The web server is operable for communicating the scripting language to the one or more web browsers to thereby generate a dynamic screen for user of the one or more web browsers. The program component engine may be operable for interacting with user initiated changes made to the dynamic screen through the scripting language whereby the program component engine interprets the scripting language to initiate a communication with the plurality of computer programs or the plurality of corresponding databases of information based on the user initiated changes made to the dynamic screen. The scripting language may comprise JavaScript or other suitable scripting languages which are generally usable on different computers having different operating systems. In one preferred embodiment the invention may further comprise a personalization component to control content received by the one or more web browsers based on a user profile. For instance, the invention may comprise an alert system for providing a personalized alert notification on the dynamic screen of the one or more web browsers related to one or more conditions within the integrated system and based on the user profile. The personalization component may also determine access to the plurality of programs and/or databases of information whereby the user profile permit utilization of the program component engine for altering the database of information through the web server. The system may further comprise a plurality of component interface files within the program component engine for interfacing with each of the plurality of computer programs. Other elements may comprise a compiler for compiling the interface files and a library of compiled component interface files for interfacing with the plurality of programs. As well, the invention may further comprise a script pre-processor for generating scripting language from the compiled component interface files and/or a script cache for storing a plurality of scripting language pages utilized within a session of communication with the one or more web browsers. In a preferred embodiment, a scripting language engine is provided within the program component engine operable for interpreting the scripting language.

In operation, a method for integrating a plurality of disparate computer systems and corresponding databases is provided which may comprise steps such as, for instance providing a web server for communicating with a plurality of internet browsers, providing interfacing files for interfacing with the plurality of disparate computer systems and corresponding databases, generating client side scripting language and server side scripting language based on the interfacing files whereby the client side scripting language and the server side scripting language operate to transmit information in two directions between the plurality of internet browsers and the web server, communicating the client side scripting language to the plurality of internet browsers through the web server, producing a dynamic screen with the client side scripting language, interpreting server side scripting language responsively to user interaction with the dynamic screen, communicating with the computer systems or the corresponding databases through the underlying computer architecture responsively to the step of interpreting the server side scripting language to produce a result, and/or communicating the result to the dynamic screen through the client side scripting language and the server side scripting language. Other steps may comprise compiling the interfacing files and forming a library of compiled interfacing files related to the plurality of disparate computer systems and corresponding databases.

It will be appreciated by those skilled in the art that the invention can be implemented using a suitable programmed general purpose computer or special purpose hardware, with program routines or logical circuit sets performing as processors. Such routines or logical circuit sets may also be referred to as processors or the like.

Therefore, it will be understood that many additional changes in the details, steps, system architectures, computer languages, interaction sequences, and the like, which have been herein described and illustrated in order to explain the nature of the invention, may be made by those skilled in the art within the principle and scope of the invention as expressed in the appended claims.

What is claimed is:

1. A system for integrating a plurality of computer programs and a plurality of corresponding databases of information into an integrated system accessible by one or more web browsers, said one or more web browsers being operable for utilizing a scripting language to produce a dynamic screen, comprising:
a program component engine operable for accessing said plurality of computer programs and said plurality of databases of information, said program component engine being operable for generating scripting language; and
a web server operable for communicating with said one or more web browsers, said web server and said plurality of system programs being separated with respect to each other such that there is no direct communication between said web server and said plurality of computer programs, said web server and said plurality of databases of information being separated with respect to each other such that there is no direct communication between said web server and said plurality of databases of information, said web server being operable for communicating said scripting language to said one or more web browsers to thereby generate a dynamic screen for user of said one or more web browsers, said program component engine being operable for interacting to user initiated changes made to said dynamic screen through said scripting language whereby said program component engine interprets said scripting language to initiate a communication with said plurality of computer programs or said plurality of corresponding databases of information based on said user initiated changes made to said dynamic screen.

2. The system of claim 1, wherein said scripting language comprises JavaScript.

3. The system of claim 1, further comprising a personalization component to control content received by said one or more web browsers based on a user profile.

4. The system of claim 3, further comprising an alert system for providing a personalized alert notification for said dynamic screen of said one or more web browsers related to one or more conditions within said integrated system and based on said user profile.

5. The system of claim 3, wherein said personalization component determines access to said database of information whereby said user profile permit utilization of said program component engine for altering said database of information through said web server.

6. The system of claim 1, further comprising a plurality of component interface files within said program component engine for interfacing with each of said plurality of computer programs.

7. The system of claim 5, further comprising a compiler for compiling said interface files and a library of compiled component interface files for interfacing with said plurality of programs.

8. The system of claim 6, further comprising a script pre-processor for generating scripting language from said compiled component interface files.

9. The system of claim 1, further comprising a script cache for storing a plurality of scripting language pages utilized within a session of communication with said one or more web browsers.

10. The system of claim 1, further comprising a scripting language engine within said program component engine, said scripting language engine being operable for interpreting said scripting language and comprising a plurality of functions embedded therein for initiating said with said plurality of computer programs or said plurality of corresponding databases of information

11. The system of claim 1, further comprising an intranet with intranet users, said intranet users having direct access to one or more of said plurality of computer programs and one or more of said plurality of corresponding databases of information without utilizing said web server.

12. The system of claim 9, wherein said intranet users have access to one or more of said plurality of computer programs and one or more of said plurality of corresponding databases of information through said web server.

13. A method for integrating a plurality of disparate computer systems and corresponding databases, each of said plurality of disparate computer systems and corresponding databases having a respective underlying computer architecture, comprising the steps of:
providing a web server for communicating with a plurality of internet browsers, said web server being unable to communicate with said plurality of disparate computer systems utilizing said respective underlying computer architecture;
providing interfacing files for interfacing with said plurality of disparate computer systems and corresponding databases;
generating client side scripting language and server side scripting language based on said interfacing files whereby said client side scripting language and said server side scripting language operate to transmit information in two directions between said plurality of internet browsers and said web server;
communicating said client side scripting language to said plurality of internet browsers through said web server;
producing a dynamic screen with said client side scripting language;
interpreting server side scripting language responsively to user interaction with said dynamic screen;
communicating with said computer systems or said corresponding databases by through said underlying computer architecture to produce a result responsively to said step of interpreting said server side scripting language; and
communicating said result to said dynamic screen through said client side scripting language and said server side scripting language.

14. The method of claim 13, further comprising compiling said interfacing files and forming a library of compiled interfacing files related to said plurality of disparate computer systems and corresponding databases.

15. The method of claim 13, further comprising providing a plurality of functions within an embedded scripting language engine for initiating actions with respect to said computer systems or said corresponding databases through said underlying computer architecture.

16. The method of claim 13, further comprising personalizing information displayed on said dynamic screen for each of said plurality of web browsers based on a user profile.

17. The method of claim 16, further comprising generating personalized alerts for each of said web browsers based on said user profile.

18. The method of claim 13, further comprising providing that at least one of said plurality of disparate computer systems and corresponding databases are utilized for producing and maintaining laboratory data, and accessing said laboratory data through said dynamic screen.

19. The method of claim 18, further comprising providing that at least one of said plurality of disparate computer systems and corresponding databases are utilized for producing and maintaining accounting data, and accessing said accounting data through said dynamic screen.

20. A system for integrating a plurality of computer programs and a plurality of corresponding databases of information into an integrated system accessible by one or more web browsers, said one or more web browsers being operable for utilizing a scripting language to produce a dynamic screen, comprising:
a web server operable for communicating with said one or more web browsers;
a program component engine operable for accessing said plurality of computer programs and said plurality of databases of information through an underlying respective architecture of said plurality of computer programs and said plurality of databases of information by utilizing interfacing files;
a scripting language generator for said program component engine operable for generating scripting language, said one or more web browsers utilizing at least a portion of said scripting language to generate a dynamic screen for a user of said one or more web browsers;
a scripting language engine within said program component engine being operable for interpreting scripting language in response to user initiated changes made to said dynamic screen; and
a plurality of callable functions embedded within said scripting language engine for producing a communication to said plurality of computer programs or said plurality of databases of information through said underlying respective architecture, said plurality of callable functions being utilized to transmit a result of said communication through said scripting language to said dynamic screen.
